(19) United States
(12) Patent Application Publication
(10) Pub. No.: US 2026/0133111 A1
(43) Pub. Date: May 14, 2026

(54) METHOD FOR MINERAL COMMINUTION ENERGY DETERMINATION AND INTELLIGENT LIBERATION DEGREE IDENTIFICATION BASED ON MORPHOLOGICAL CHARACTERISTICS OF PARTICLES

(71) Applicant: Zhengzhou University, Zhengzhou (CN)

(72) Inventors: Liang SI, Zhengzhou (CN); Yijun CAO, Zhengzhou (CN); Ruolan WANG, Zhengzhou (CN); Wei WANG, Zhengzhou (CN); Bio FU, Zhengzhou (CN); Guizhong XIE, Zhengzhou (CN); We Iran ZUO, Zhengzhou (CN); Handed CHAO, Zhengzhou (CN)

(73) Assignee: Zhengzhou University, Zhengzhou (CN)

(21) Appl. No.: 19/443,517

(22) Filed: Jan. 8, 2026

(30) Foreign Application Priority Data
Jan. 9, 2025 (CN) 202510032664.4
Jan. 21, 2025 (CN) 202510089221.9

(51) Int. Cl. G01N 15/0227; G01N 15/02

(52) U.S. Cl. CPC G01N 15/0227; G01N 15/0266

(57) ABSTRACT

In a method for mineral comminution energy determination and intelligent liberation degree identification based on morphological characteristics of particles, magnetite ore is comminuted with a drop weight impact testing machine and then subjected to particle size classification. Liberation degrees of the comminuted particles of some particle size classes with small relative particle sizes when different comminution energy is applied are detected and recorded using a mineral liberation analyzer. Profiles of liberation degrees of different minerals are established according to the detected data. The profiles are analyzed to determine appropriate comminution energy E, and then the comminuted particles of the particle size classes with the comminution energy are scanned by an electron microscope to obtain electron microscope images. Proportions of intergranular fractures of the particle size classes are counted. Comminution energy E1 corresponding to the particle size classes is calculated based on a function.

### CROSS-REFERENCE TO RELATED APPLICATIONS

This application claims priorities to Chinese Patent Application No. 202510032664.4 with a filing date of Jan. 9, 2025, and Chinese Patent Application No. 202510089221.9 with a filing date of Jan. 21, 2025. The content of the aforementioned applications, including any intervening amendments thereto, is incorporated herein by reference.

### TECHNICAL FIELD

The present disclosure relates to the technical field of states of liberation of mineral components after ore comminution, and in particular, to a method for mineral comminution energy determination and intelligent liberation degree identification based on morphological characteristics of particles.

### BACKGROUND

The main task of comminution is to achieve the mutual liberation of different mineral components in the ore. Mineral liberation is achieved by reducing the size of ore particles through comminution. The liberation degree of the target mineral directly influences the selection of subsequent processes and the effectiveness of separation. Grinding of metallic ores is liberation-oriented grinding. Ores are aggregates of different minerals, and the bonding forces at the interfaces between different mineral aggregates are smaller than the cohesive forces between particles within the minerals. As a result, mineral liberation and size reduction may not occur simultaneously. When appropriate energy is applied, liberation between different minerals takes precedence, followed by size reduction. Therefore, mineral liberation behavior is directly influenced by the magnitude of the applied comminution energy.

The essence of particle size evolution and component liberation during the comminution process of magnetite ore particles lies in intergranular and transgranular fractures within and between phases. Completely liberated magnetite and quartz will be produced during the magnetite ore comminution process.

Fracture at the interfaces of magnetite ore, especially fractures at grain boundaries of different minerals in the ore, can enhance mineral liberation. Mineral interfaces are areas of weak bonding forces. With appropriate comminution energy, intergranular cracks are fractured along these interfaces, resulting in intergranular fracture. Thus, for magnetite ore, a higher proportion of intergranular fracture at the interfaces of different minerals will increase the liberation degrees of individual minerals.

The magnitude of the applied energy directly affects the fracture mode of the ore. As comminution energy increases, the fracture mode of magnetite ore shifts to transgranular fracture. Determining the appropriate comminution energy to achieve a suitable mineral liberation degree after magnetite ore comminution is beneficial for the selection of subsequent processes and separation. It is necessary to find a suitable method for analyzing a relationship between comminution energy and a mineral liberation degree. Such analysis is of significant importance for guiding the comminution process of magnetite ore and selecting appropriate comminution energy based on this relationship.

### SUMMARY OF PRESENT INVENTION

An objective of the present disclosure is to provide a method for mineral comminution energy determination and intelligent liberation degree identification based on morphological characteristics of particles for addressing the aforementioned problems.

The technical solutions of the present disclosure are as follows: includes the following steps:
a, comminuting a magnetite ore sample with a drop weight impact testing machine to obtain communuted ore particles, and sieving the comminuted ore particles for particle size classification to obtain a plurality of classes of classified particles;
b, using a mineral liberation analyzer to measure and record mineral liberation degrees of small-sized particles obtained after the particle size classification, where as found through preliminary observations by the inventors, the comminuted particles of large particle size classes exhibit low mineral liberation degrees and hold no value and significance for subsequent separation; and therefore, particles with small particle sizes are selected for measurement because the working efficiency will be affected if all particles are measured;
c, adjusting impact comminution energy of the drop weight impact testing machine and iterating the steps a and b for a plurality of times;
d, establishing a profile of magnetite liberation degrees at different levels of comminution energy and a profile of quartz liberation degrees at different levels of comminution energy, where the relationship between a liberation degree and comminution energy can be analyzed more intuitively;
e, performing analysis based on the two profiles in the step d to determine an appropriate comminution energy E for the classified particles with a particle size class of A, wherein the appropriate comminution energy E is the comminution energy that the classified particles with the particle size class of A have highest liberation degrees;
f, comminuting the magnetite ore sample with an actual comminution energy of the appropriate comminution energy E, and scanning, by an electron microscope, the plurality of classes of classified particles to obtain proportions of intergranular fractures in particle fractures for the plurality of classes of classified particles;
g, calculating a theoretical comminution energy E1 corresponding to each class of the classified particles according to a function relationship between the proportions of intergranular fractures and the theoretical comminution energy of each class of the classified particles; and
h, comparing the calculated theoretical comminution energy with the actual comminution energy to obtain an error for each class of the classified particles; determining that the calculated theoretical communition energy E1 of the classified particles with a particle size class of B corresponding to the error less than a preset value is the actual comminution energy, and determining that the proportions of intergranular fractures of the classified particles with the particle size class of B are capable of being used to determine the actual comminution energy for the magnetite ore sample. Based on the known relationship between the proportions of intergranular fractures and the theoretical comminution energy, a relationship is established between mineral liberation degrees of readily separable particle classes and comminution energy. This allows for the reverse control of the mineral liberation degrees of the readily separable particle classes based on the comminution energy, thereby optimizing the comminution process based on the comminution energy and improving the comminution effect.

Preferably, the method is carried out for single-particle magnetite ore, and the sample in the step a is of Φ 50*25 mm;
in the step a, the plurality of classes of classified particles is as follows: −1.180+0.900 mm, −0.900+0.600 mm, −0.600+0.300 mm, −0.300+0.150 mm, −0.150+0.074 mm, −0.074+0.038 mm, and −0.038+0.019 mm;
in the step b, the small-sized particles refer to particles with a particle size of −0.300+0.150 mm, −0.150+0.074 mm, −0.074+0.038 mm, and −0.038+0.019 mm are measured and recorded;
in the step c, energy applied to impact comminution for a plurality of times is 226.01 J, 376.69 J, 527.36 J, 640.37 J, 753.38 J, and 866.38 J, respectively;
in the step e, the particles with the particle size class of A is the particles with the particle size of −0.074+0.038 mm and −0.038+0.019 mm, the highest liberation degrees are 64.71% and 83.49%, respectively, and the appropriate comminution energy E is determined to be 753.38 J;
in the step f, comminuted magnetite ore particles of the particle size classes −1.180+0.900 mm, −0.900+0.600 mm, −0.600+0.300 mm, −0.300+0.150 mm, −0.150+0.074 mm, −0.074+0.038 mm, −0.038+0.019 mm when the comminution energy is 753.38 J are scanned by the electron microscope to obtain the proportions of intergranular fractures in the particle fractures in the particle size classes; and
in the step h, the errors between E1 and E calculated for the particle size classes −1.180+0.900 mm, −0.900+0.600 mm, and −0.600+0.300 mm are determined to be less than the preset value of 6%, and are 3.77%, 5.93%, and 1.52%, respectively, and the particle size classes −1.180+0.900 mm, −0.900+0.600 mm, and −0.600+0.300 mm are defined as the particle size class of B.

Preferably, the method is carried out for particle-aggregate magnetite ore; the sample in the step a is a magnetite ore particle aggregate of the particle size class −2.000+1.180 mm, and 150 g of the sample is taken for each experiment;
in the step a, the plurality of classes of classified particles is as follows: −1.180+0.900 mm, −0.900+0.600 mm, −0.600+0.300 mm, −0.300+0.150 mm, −0.150+0.074 mm, −0.074+0.038 mm, and −0.038+0.019 mm;
in the step b, the small-sized particles refers to particles with a particle size of −0.300+0.150 mm, −0.150+0.074 mm, −0.074+0.038 mm, and −0.038+0.019 mm;
in the step c, energy applied to impact comminution, namely impacting for a plurality of times is 332.59 J, 432.36 J, 532.14 J, 631.25 J, and 731.69 J, respectively;
in the step e, the particles with the particle size class of A is the particles with the particle size of −0.074+0.038 mm and −0.038+0.019 mm, the highest liberation degrees are 69.57% and 84.03%, respectively, and the appropriate comminution energy E is determined to be 432.36 J;
in the step f, comminuted magnetite ore particles of the particle size classes −1.180+0.900 mm, −0.900+0.600 mm, −0.600+0.300 mm, −0.300+0.150 mm, −0.150+0.074 mm, −0.074+0.038 mm, −0.038+0.019 mm when the comminution energy is 432.36 J are scanned by the electron microscope to obtain the proportions of intergranular fractures in the particle fractures in the particle size classes; and
in the step h, the errors between E1 and E calculated for the particle size classes −1.180+0.900 mm, −0.900+0.600 mm, −0.600+0.300 mm, −0.300+0.150 mm, and −0.150+0.074 mm are determined to less than the preset value, and are within 5%, and the particle size classes −1.180+0.900 mm, −0.900+0.600 mm, −0.600+0.300 mm, −0.300+0.150 mm are defined as the particle size class of B.

Preferably, the function relationship between the proportions of intergranular fractures of the particle size classes and the theoretical comminution energy in the step g is obtained through following steps:
41, comminuting the magnetite ore sample with the drop weight impact testing machine, selecting comminuted particles of single-particle magnetite ore under same comminution energy, sieving the comminuted magnetite ore particles for classification, obtaining images of fractures of the magnetite ore particles of different particle size classes through electron microscope scanning, and counting the proportions of intergranular fractures in the fractures for each particle size class;
42, adjusting the comminution energy of the drop weight impact testing machine, repeating the step 41 for a plurality of times, sequentially performing morphology characterization on the fractures of the comminuted magnetite ore particles of different particle size classes with different comminution energy, and counting the proportions of intergranular fractures in the fractures for each particle size class; and
43, summarizing data in the step 42, plotting points in a coordinate system, fitting a curve according to the plotted points, and establishing the function relationship between the proportions of intergranular fractures of the comminuted magnetite ore particles s and comminution energy according to the fitted curve for each particle size class. By these substeps, the function relationship between the proportions of intergranular fractures and the theoretical comminution energy is obtained, establishing a precondition for performing the previous step g.

Preferably, in the step 41, the proportions of intergranular fractures in the fractures are counted by a software-based image identification method. By establishing a computer software-based identification method, the efficiency can be improved so that the previous step 42 can be carried out rapidly and the value of industrial application can be produced. The software-based image identification method includes:
51, comminuting the magnetite ore with the drop weight impact testing machine, collecting and dividing equally the comminuted magnetite ore particles into N groups, spreading the comminuted magnetite ore particles of each of the N groups for electron microscope scanning, and importing N scanned images to a computer, N≥1000;
52, manually characterizing different particle surface morphologies in regions of each of the scanned images as one of two types of intergranular fracture or transgranular fracture, counting a number of particles of the intergranular fracture and a number of particles of the transgranular fracture in the image, and repeating the present step to obtain N characterized images;
53, establishing in the computer a single shot multibox detector (SSD) algorithm-based fully convolutional neural network model that is trained by learning the characterized images in the step 52;
54, importing a large part of the characterized images in the step 52 to the SSD algorithm-based fully convolutional neural network model on the computer for deep learning training to obtain an image identification model, testing the image identification model with the remaining part of the characterized images, stopping the deep learning training in response to a satisfactory accuracy rate tested, and retaining the trained image identification model; in response to an unsatisfactory accuracy rate tested, continuing with the deep learning training and the testing until the accuracy rate tested is satisfactory, and retaining the trained image identification model, where the model established after the SSD algorithm-based fully convolutional neural network model learns a large number of manually characterized images can improve the identification efficiency, facilitating industrial application, and can rapidly obtain the results of the proportions of intergranular fractures; and
55, docking software with the image identification model obtained in the step 54 in the computer and completing the step 41 using the software.

The present disclosure has the following beneficial effects, this method is capable of obtaining the appropriate comminution energy for the magnetite ore. In actual impact comminution, materials (e.g. steel balls) for impact comminution in the drop weight impact machine will be consumed continuously. The comminution energy set on the machine is usually different from the actual comminution energy applied to the magnetite ore due to the consumption of the material for impact comminution. Thus, it is hard to determine the actual comminution energy for the magnetite ore in the drop weight impact machine. It is hence hard for the user to determine whether the set comminution energy set on the machine is the appropriate comminution energy or not. This method is capable of determining the actual comminution energy through the proportions of intergranular fractures of the classified particles and the relationship between the proportions of intergranular fractures and the comminution energy of each class of the classified particles. When the actual comminution energy is determined, the user is capable of adjusting the comminution energy by adding or reducing materials for impact comminution in the machine to make the actual comminution energy to be approximate to the appropriate comminution energy. Thus, the energy efficiency for comminution is improved.

### BRIEF DESCRIPTION OF THE DRAWINGS

FIG. 1 shows a profile of magnetite liberation degrees at different levels of comminution energy for single-particle magnetite ore according to the present disclosure;

FIG. 2 shows a profile of quartz liberation degrees at different levels of comminution energy for single-particle magnetite ore according to the present disclosure;

FIG. 3 is a comparison diagram illustrating proportions of intergranular fractures and errors of calculated comminution energy E1 for particle size classes after comminution of single-particle magnetite ore according to the present disclosure;

FIG. 4 shows a profile of magnetite liberation degrees at different levels of comminution energy for particle-aggregate magnetite ore according to the present disclosure;

FIG. 5 shows a profile of quartz liberation degrees at different levels of comminution energy for particle-aggregate magnetite ore according to the present disclosure;

FIG. 6 is a comparison diagram illustrating proportions of intergranular fractures and errors of calculated comminution energy E1 for particle size classes after comminution of particle-aggregate magnetite ore according to the present disclosure; and

FIG. 7 shows fitted curves showing function relationship between the proportions of intergranular fractures of the comminuted magnetite ore particles and comminution energy for each particle size class.

### DETAILED DESCRIPTION OF THE EMBODIMENTS

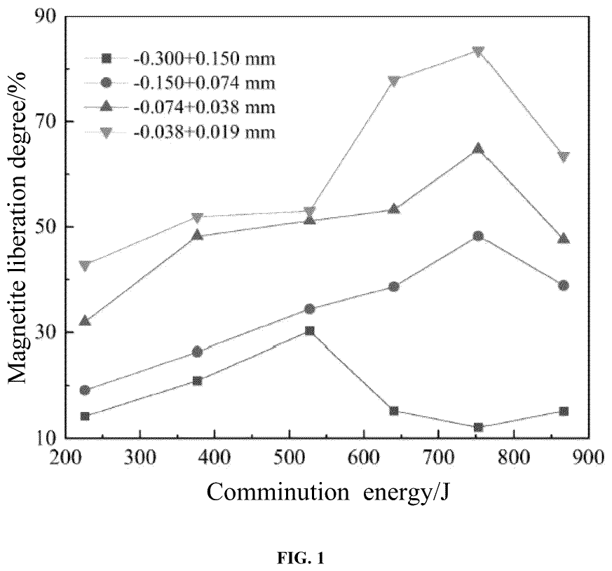

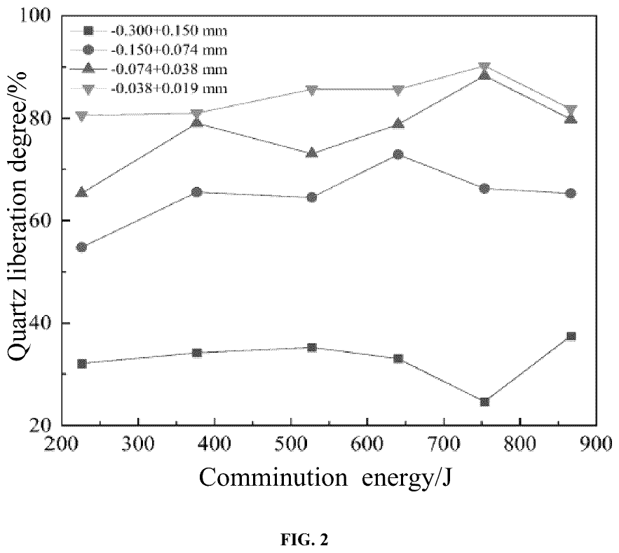

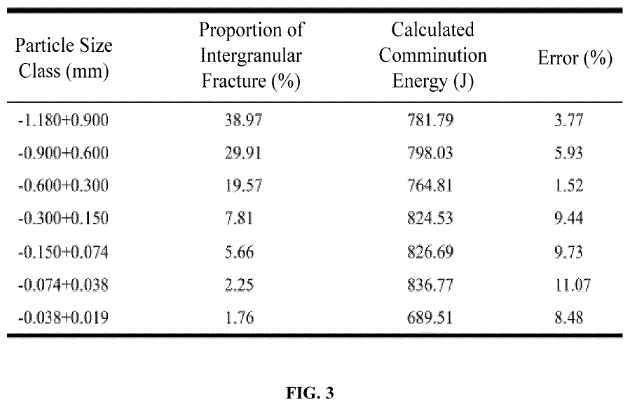

Embodiment 1: With reference to FIG. 1 to FIG. 3, a method for mineral comminution energy determination and intelligent liberation degree identification based on morphological characteristics of particles includes the following steps.

In step a, a magnetite ore sample is comminuted with a drop weight impact testing machine, and the comminuted ore particles are sieved for particle size classification. The method is carried out for single-particle magnetite ore, and the sample in step a is of Φ 50*25 mm. The particle size classification is as follows: −1.180+0.900 mm, −0.900+0.600 mm, −0.600+0.300 mm, −0.300+0.150 mm, −0.150+0.074 mm, −0.074+0.038 mm, and −0.038+0.019 mm.

In step b, a mineral liberation analyzer is used to measure and record mineral liberation degrees of particles with small particle sizes of four particle size classes −0.300+0.150 mm, −0.150+0.074 mm, −0.074+0.038 mm, and −0.038+0.019 mm obtained after the particle size classification. As found through preliminary observations by the inventors, the comminuted particles of large particle size classes exhibit low mineral liberation degrees and hold no value and significance for subsequent separation; and therefore, particles with small particle sizes are selected for measurement because the working efficiency will be affected if all particles are measured.

In step c, impact comminution energy of the drop weight impact testing machine is adjusted and steps a and b are performed for a plurality of times.

Energy applied to impact comminution for a plurality of times is 226.01 J, 376.69 J, 527.36 J, 640.37 J, 753.38 J, and 866.38 J, respectively.

In step d, a profile of magnetite liberation degrees at different levels of comminution energy and a profile of quartz liberation degrees at different levels of comminution energy are established based on records in step c. The relationship between a liberation degree and comminution energy can be analyzed more intuitively.

In step e, analysis is performed based on the two profiles in step d to determine highest liberation degrees of mineral particles corresponding to a particle size class of A, and a certain level of comminution energy is determined as appropriate comminution energy E. The comminution energy corresponding to the highest liberation degree after focused comminution is the appropriate comminution energy, offering stronger guidance. Specifically, when the comminution energy is 753.38 J, liberation degrees of comminuted magnetite ore particles of the particle size classes −0.074+0.038 mm and −0.038+0.019 mm are highest and are 64.71% and 83.49%, respectively, and the particle size classes −0.074+0.038 mm and −0.038+0.019 mm are defined as the particle size class of A, and the appropriate comminution energy E is determined to be 753.38 J.

In step f, particles of the particle size classes with the appropriate comminution energy E are scanned by an electron microscope to obtain proportions of intergranular fractures in particle fractures in the particle size classes. Comminuted magnetite ore particles of the particle size classes −1.180+0.900 mm, −0.900+0.600mm, −0.600+0.300 mm, −0.300+0.150 mm, −0.150+0.074 mm, −0.074+0.038 mm, −0.038+0.019 mm when the comminution energy is 753.38 J are scanned by the electron microscope to obtain the proportions of intergranular fractures in the particle fractures in the particle size classes.

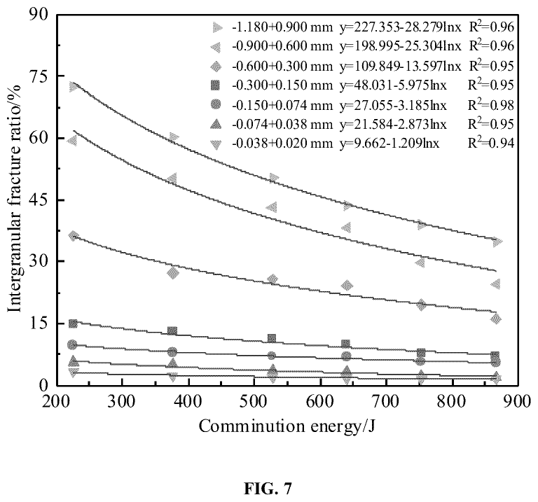

In step g, comminution energy E1 corresponding to each of the particle size classes is calculated according to a function relationship between the proportions of intergranular fractures and comminution energy, particularly in accordance with the known relationship between the proportions of intergranular fractures and comminution energy as shown in FIG. 7.

In step h, E1 is compared with E to obtain an error. The calculated theoretical communition energy E1 of the classified particles with a particle size class of B corresponding to the error less than a preset value is determined as the actual comminution energy, and the proportions of intergranular fractures of the comminuted particles with the particle size class of B are determined to be capable of being used to determine the actual comminution energy for the magnetite ore. Based on the known relationship between the proportions of intergranular fractures and comminution energy, a relationship is established between mineral liberation degrees of readily separable particle classes and comminution energy. This allows for the reverse control of the mineral liberation degrees of the readily separable particle classes based on the comminution energy, thereby optimizing the comminution process based on the comminution energy and improving the comminution effect. The errors between E1 and E calculated for the particle size classes −1.180+0.900 mm, −0.900+0.600 mm, and −0.600+0.300 mm are determined to be small, less than 6%, and are 3.77%, 5.93%, and 1.52%, respectively, and the particle size classes −1.180+0.900 mm, −0.900+0.600 mm, and −0.600+0.300 mm are defined as the particle size class of B.

The function relationship between the proportions of intergranular fractures of the particle size classes and comminution energy in step g is obtained through following steps:

In step 41, the magnetite ore sample is comminuted with the drop weight impact testing machine. Comminuted particles of single-particle magnetite ore with same comminution energy are selected. The comminuted magnetite ore particles are sieved for classification. Images of fractures of the magnetite ore particles of different particle size classes are obtained through electron microscope scanning, and the proportions of intergranular fractures in the fractures are counted.

In step 42, the comminution energy of the drop weight impact testing machine is adjusted. Step 41 is repeated for a plurality of times. Morphology characterization is sequentially performed on the fractures of the comminuted magnetite ore particles of different particle size classes with different comminution energy, and the proportions of intergranular fractures in the fractures are counted.

In step 43, data in step 42 is summarized. Points are plotted in a coordinate system. A curve is fitted according to the plotted points, and the function relationship between the proportions of intergranular fractures of the comminuted magnetite ore particles of different particle size classes and comminution energy is established according to the fitted curve. By these substeps, the function relationship between the proportions of intergranular fractures and comminution energy is obtained, establishing a precondition for performing the previous step g.

In step 41, the proportions of intergranular fractures in the fractures are counted by a software-based image identification method. By establishing a computer software-based identification method, the efficiency can be improved so that the previous step 42 can be carried out rapidly and the value of industrial application can be produced. The software-based image identification method includes the following process.

In step 51, the magnetite ore is comminuted with the drop weight impact testing machine. The comminuted magnetite ore particles are collected and divided equally into N groups. The comminuted magnetite ore particles of each of the N groups are spread for electron microscope scanning, and N scanned images are imported to a computer, N≥1000.

In step 52, different particle surface morphologies in regions of each of the scanned images are manually characterized as one of two types of intergranular fracture or transgranular fracture, and a number of particles of the intergranular fracture and a number of particles of the transgranular fracture in the image are counted. This step is repeated to obtain N characterized images.

In step 53, an SSD algorithm-based fully convolutional neural network model that is trained by learning the characterized images in step 52 is established in the computer.

In step 54, a large part of the characterized images in step 52 is imported to the SSD algorithm-based fully convolutional neural network model on the computer for deep learning training to obtain an image identification model. The image identification model is tested with the remaining part of the characterized images. The deep learning training is stopped in response to a satisfactory accuracy rate tested, and the trained image identification model is retained. In response to an unsatisfactory accuracy rate tested, the deep learning training and the testing are continued until the accuracy rate tested is satisfactory, and the trained image identification model is retained. The model established after the SSD algorithm-based fully convolutional neural network model learns a large number of manually characterized images can improve the identification efficiency, facilitating industrial application, and can rapidly obtain the results of the proportions of intergranular fractures.

In step 55, software is docked with the image identification model obtained in step 54 in the computer and step 41 is completed using the software.

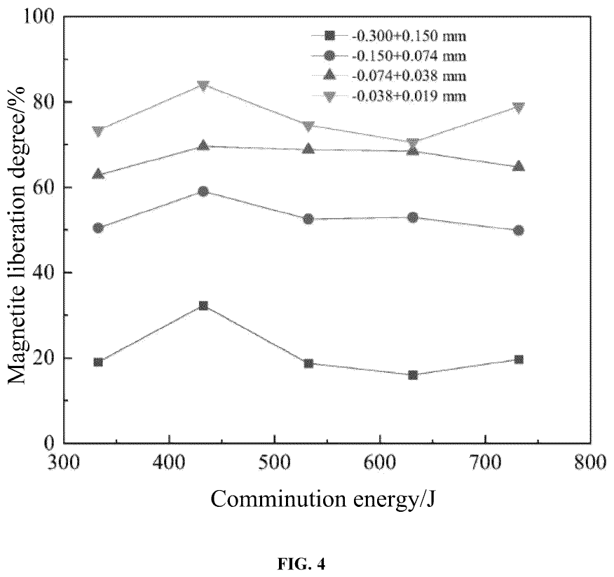

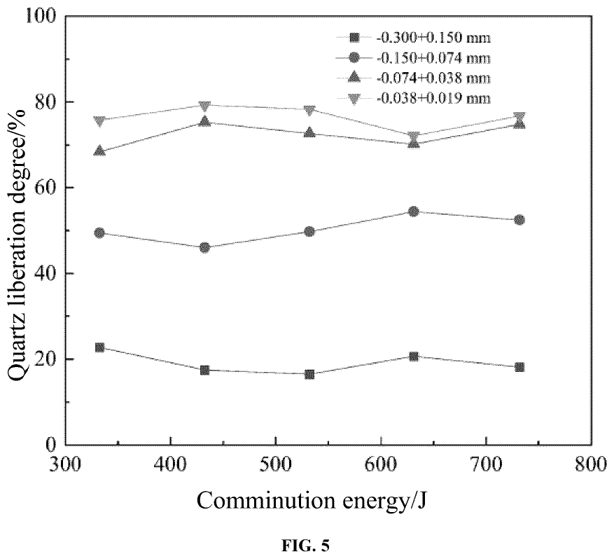

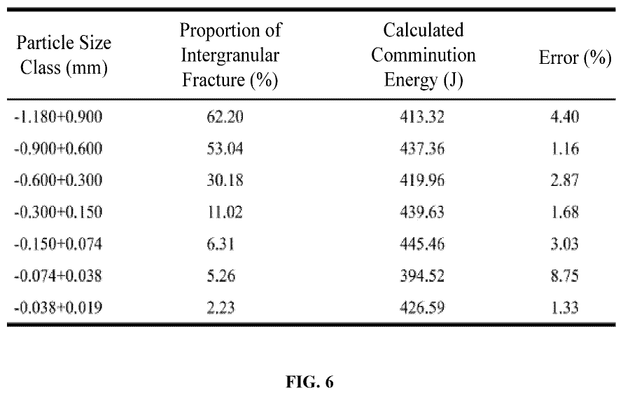

Embodiment 2: With reference to FIG. 4 to FIG. 6, a method for mineral comminution energy determination and intelligent liberation degree identification based on morphological characteristics of particles is carried out for particle-aggregate magnetite ore and includes the following steps.

In step a, a magnetite ore sample is comminuted with a drop weight impact testing machine, and the comminuted ore particles are sieved for particle size classification. The sample in step a is a magnetite ore particle aggregate of the particle size class −2.000+1.180 mm, and 150 g of the sample is taken for each experiment. The particle size classification after comminution is as follows: −1.180+0.900 mm, −0.900+0.600 mm, −0.600+0.300 mm, −0.300+0.150 mm, −0.150+0.074 mm, −0.074+0.038 mm, and −0.038+0.019 mm.

In step b, a mineral liberation analyzer is used to measure and record mineral liberation degrees of small-sized particles obtained after the particle size classification. In step b, mineral liberation degrees of particles of particle size classes −0.300+0.150 mm, −0.150+0.074 mm, −0.074+0.038 mm, and −0.038+0.019 mm are measured and recorded. As found through preliminary observations by the inventors, the comminuted particles of large particle size classes exhibit low mineral liberation degrees and hold no value and significance for subsequent separation; and therefore, particles with small particle sizes are selected for measurement because the working efficiency will be affected if all particles are measured.

In step c, impact comminution energy of the drop weight impact testing machine is adjusted and steps a and b are performed for a plurality of times. Energy applied to impact comminution, namely impacting for a plurality of times is 332.59 J, 432.36 J, 532.14 J, 631.25 J, and 731.69 J, respectively.

In step d, a profile of magnetite liberation degrees at different levels of comminution energy and a profile of quartz liberation degrees at different levels of comminution energy are established based on records in step c. The relationship between a liberation degree and comminution energy can be analyzed more intuitively.

In step e, analysis is performed based on the two profiles in step d to determine high liberation degrees of mineral particles corresponding to a particle size class of A, and a certain level of comminution energy is determined as appropriate comminution energy E. The comminution energy corresponding to a high liberation degree after focused comminution is the appropriate comminution energy, offering stronger guidance. When the comminution energy is 432.36 J, liberation degrees of comminuted magnetite ore particles of the particle size classes −0.074+0.038 mm and −0.038+0.019 mm are high and are 69.57% and 84.03%, respectively, and the particle size classes are defined as the particle size class of A, and the appropriate comminution energy E is determined to be 432.36 J;

In step f, particles of the particle size classes with the appropriate comminution energy E are scanned by an electron microscope to obtain proportions of intergranular fractures in particle fractures in the particle size classes. Comminuted magnetite ore particles of the particle size classes −1.180+0.900 mm, −0.900+0.600mm, −0.600+0.300 mm, −0.300+0.150 mm, −0.150+0.074 mm, −0.074+0.038 mm, −0.038+0.019 mm when the comminution energy is 432.36 J are scanned by the electron microscope to obtain the proportions of intergranular fractures in the particle fractures in the particle size classes.

In step g, comminution energy E1 corresponding to each of the particle size classes is calculated based on the proportions of intergranular fractures obtained in step f and according to a function relationship between the proportions of intergranular fractures and comminution energy, particularly in accordance with the known relationship between the proportions of intergranular fractures and comminution energy.

In step h, E1 is compared with E to obtain an error range. Small errors between E1 and E corresponding to a particle size class of B are determined, and the appropriate comminution energy E may be calculated and inferred from proportions of intergranular fractures of the comminuted particles corresponding to the particle size class of B. The errors between E1 and E calculated for the particle size classes −1.180+0.900 mm, −0.900+0.600 mm, −0.600+0.300 mm, −0.300+0.150 mm, and −0.150+0.074 mm are determined to be small, and are within 5%, and the particle size classes are defined as the particle size class of B. Based on the known relationship between the proportions of intergranular fractures and comminution energy, a relationship is established between mineral liberation degrees of readily separable particle classes and comminution energy. This allows for the reverse control of the mineral liberation degrees of the readily separable particle classes based on the comminution energy, thereby optimizing the comminution process based on the comminution energy and improving the comminution effect.

The function relationship between the proportions of intergranular fractures of the particle size classes and comminution energy in step g is obtained through following steps:

In step 41, the magnetite ore sample is comminuted with the drop weight impact testing machine. Comminuted particles of single-particle magnetite ore with same comminution energy are selected. The comminuted magnetite ore particles are sieved for classification. Images of fractures of the magnetite ore particles of different particle size classes are obtained through electron microscope scanning, and the proportions of intergranular fractures in the fractures are counted.

In step 42, the comminution energy of the drop weight impact testing machine is adjusted. Step 41 is repeated for a plurality of times. Morphology characterization is sequentially performed on the fractures of the comminuted magnetite ore particles of different particle size classes with different comminution energy, and the proportions of intergranular fractures in the fractures are counted.

In step 43, data in step 42 is summarized. Points are plotted in a coordinate system. A curve is fitted according to the plotted points, and the function relationship between the proportions of intergranular fractures of the comminuted magnetite ore particles of different particle size classes and comminution energy is established according to the fitted curve. By these substeps, the function relationship between the proportions of intergranular fractures and comminution energy is obtained, establishing a precondition for performing the previous step g.

In step 41, the proportions of intergranular fractures in the fractures are counted by a software-based image identification method. By establishing a computer software-based identification method, the efficiency can be improved so that the previous step 42 can be carried out rapidly and the value of industrial application can be produced. The software-based image identification method includes the following process.

In step 51, the magnetite ore is comminuted with the drop weight impact testing machine. The comminuted magnetite ore particles are collected and divided equally into N groups. The comminuted magnetite ore particles of each of the N groups are spread for electron microscope scanning, and N scanned images are imported to a computer, N≥1000.

In step 52, different particle surface morphologies in regions of each of the scanned images are manually characterized as one of two types of intergranular fracture or transgranular fracture, and a number of particles of the intergranular fracture and a number of particles of the transgranular fracture in the image are counted. This step is repeated to obtain N characterized images.

In step 53, an SSD algorithm-based fully convolutional neural network model that is trained by learning the characterized images in step 52 is established in the computer.

In step 54, a large part of the characterized images in step 52 is imported to the SSD algorithm-based fully convolutional neural network model on the computer for deep learning training to obtain an image identification model. The image identification model is tested with the remaining part of the characterized images. The deep learning training is stopped in response to a satisfactory accuracy rate tested, and the trained image identification model is retained. In response to an unsatisfactory accuracy rate tested, the deep learning training and the testing are continued until the accuracy rate tested is satisfactory, and the trained image identification model is retained. The model established after the SSD algorithm-based fully convolutional neural network model learns a large number of manually characterized images can improve the identification efficiency, facilitating industrial application, and can rapidly obtain the results of the proportions of intergranular fractures.

55, software is docked with the image identification model obtained in step 54 in the computer and step 41 is completed using the software.

What is claimed is:

1. A method for mineral comminution energy determination and intelligent liberation degree identification based on morphological characteristics of particles, comprising following steps:
a, comminuting a magnetite ore sample with a drop weight impact testing machine to obtain communuted ore particles, and sieving the comminuted ore particles for particle size classification to obtain a plurality of classes of classified particles;
b, using a mineral liberation analyzer to measure and record mineral liberation degrees of particles with a first size class in the classified particles;
c, adjusting impact comminution energy of the drop weight impact testing machine and iterating the steps a and b for a plurality of times;
d, establishing a profile of magnetite liberation degrees at different levels of comminution energy and a profile of quartz liberation degrees at different levels of comminution energy;
e, performing analysis based on the profile of magnetite liberation degrees and the profile of quartz liberation degrees obtained in the step d to determine an appropriate comminution energy E for the classified particles with a particle size class of A, wherein the appropriate comminution energy E is the comminution energy that the classified particles with the particle size class of A have highest liberation degrees;
f, comminuting the magnetite ore sample with an actual comminution energy of the appropriate comminution energy E, and scanning, by an electron microscope, the plurality of classes of classified particles to obtain proportions of intergranular fractures in particle fractures ;
g, calculating a theoretical comminution energy E1 corresponding to each class of the classified particles according to a function relationship between the proportions of intergranular fractures and the theoretical comminution energy of each class of the classified particles; and
h, comparing the calculated theoretical comminution energy with the actual comminution energy to obtain an error for each class of the classified particles; determining that the calculated theoretical communition energy E1 of the classified particles with a particle size class of B corresponding to the error less than a preset value is the actual comminution energy, and determining that the proportions of intergranular fractures of the classified particles with the particle size class of B are capable of being used to determine the actual comminution energy for the magnetite ore sample.

2. The method according to claim 1, wherein the method is carried out for single-particle magnetite ore, and the sample in the step a is of Φ 50*25 mm;
in the step a, the plurality of classes of classified particles is as follows: −1.180+0.900 mm, −0.900+0.600 mm, −0.600+0.300 mm, −0.300+0.150 mm, −0.150+0.074 mm, −0.074+0.038 mm, and −0.038+0.019 mm;
in the step b, the particles with the first size class refer to particles with a particle size of −0.300+0.150 mm, −0.150+0.074 mm, −0.074+0.038 mm, and −0.038+0.019mm;
in the step c, energy applied to impact comminution for a plurality of times is 226.01 J, 376.69 J, 527.36 J, 640.37 J, 753.38 J, and 866.38 J, respectively;
in the step e, the particles with the particle size class of A is the particles with the particle size of −0.074+0.038 mm and −0.038+0.019 mm, the highest liberation degrees are 64.71% and 83.49%, respectively, and the appropriate comminution energy E is determined to be 753.38 J;
in the step f, comminuted magnetite ore particles of particle size classes −1.180+0.900 mm, −0.900+0.600 mm, −0.600+0.300 mm, −0.300+0.150 mm, −0.150+0.074 mm, −0.074+0.038 mm, −0.038+0.019 mm when the comminution energy is 753.38 J are scanned by the electron microscope to obtain the proportions of intergranular fractures in the particle fractures in the particle size classes; and
in the step h, the errors between E1 and E calculated for the particle size classes −1.180+0.900 mm, −0.900+0.600 mm, and −0.600+0.300 mm are determined to be less than the preset value, and are 3.77%, 5.93%, and 1.52%, respectively, and the particle size classes −1.180+0.900 mm, −0.900+0.600 mm, and −0.600+0.300 mm are defined as the particle size class of B.

3. The method according to claim 1, wherein the method is carried out for particle-aggregate magnetite ore; the magnetite ore sample in the step a is a magnetite ore particle aggregate of the particle size class −2.000+1.180 mm, and 150 g of the magnetite ore sample is taken for each experiment;
in the step a, the plurality of classes of classified particles is as follows: −1.180+0.900 mm, −0.900+0.600 mm, −0.600+0.300 mm, −0.300+0.150 mm, −0.150+0.074 mm, −0.074+0.038 mm, and −0.038+0.019 mm;
in the step b, the particles with the first size class refers to particles with a particle size of −0.300+0.150 mm, −0.150+0.074 mm, −0.074+0.038 mm, and −0.038+0.019 mm;
in the step c, energy applied to impact comminution, namely impacting for a plurality of times is 332.59 J, 432.36 J, 532.14 J, 631.25 J, and 731.69 J, respectively;
in the step e, the particles with the particle size class of A is the particles with the particle size of −0.074+0.038 mm and −0.038+0.019 mm, the highest liberation degrees are 69.57% and 84.03%, respectively, and the appropriate comminution energy E is determined to be 432.36 J;
in the step f, comminuted magnetite ore particles of particle size classes −1.180+0.900 mm, −0.900+0.600 mm, −0.600+0.300 mm, −0.300+0.150 mm, −0.150+0.074 mm, −0.074+0.038 mm, −0.038+0.019 mm when the comminution energy is 432.36 J are scanned by the electron microscope to obtain the proportions of intergranular fractures in the particle fractures in the particle size classes; and
in the step h, the errors between E1 and E calculated for the particle size classes −1.180+0.900 mm, −0.900+0.600 mm, −0.600+0.300 mm, −0.300+0.150 mm, and −0.150+0.074 mm are determined to be less than the preset value, and are within 5%, and the particle size classes −1.180+0.900 mm, −0.900+0.600 mm, −0.600+0.300 mm, −0.300+0.150 mm, and −0.150+0.074 mm are defined as the particle size class of B.

4. The method according to claim 1, wherein the function relationship between the proportions of intergranular fractures and the theoretical comminution energy in the step g is obtained through following steps:
41, comminuting the magnetite ore sample with the drop weight impact testing machine, selecting comminuted particles of single-particle magnetite ore under same comminution energy, sieving the comminuted magnetite ore particles for classification, obtaining images of fractures of the magnetite ore particles of different particle size classes through electron microscope scanning, and counting the proportions of intergranular fractures in the fractures for each particle size class;
42, adjusting the comminution energy of the drop weight impact testing machine, repeating the step 41 for a plurality of times, sequentially performing morphology characterization on the fractures of the comminuted magnetite ore particles of different particle size classes with different comminution energy, and counting the proportions of intergranular fractures in the fractures for each particle size class; and
43, summarizing data in the step 42, plotting points in a coordinate system, fitting a curve according to the plotted points, and establishing the function relationship between the proportions of intergranular fractures of the comminuted magnetite ore particles and comminution energy for each particle size class according to the fitted curve.

5. The method according to claim 4, wherein in the step 41, the proportions of intergranular fractures in the fractures are counted by a software-based image identification method comprising:
51, comminuting the magnetite ore with the drop weight impact testing machine, collecting and dividing equally the comminuted magnetite ore particles into N groups, spreading the comminuted magnetite ore particles of each of the N groups for electron microscope scanning, and importing N scanned images to a computer, N≥1000;
52, manually characterizing different particle surface morphologies in regions of each of the scanned images as one of two types of intergranular fracture or transgranular fracture, counting a number of particles of the intergranular fracture and a number of particles of the transgranular fracture in the image, and repeating the present step to obtain N characterized images;
53, establishing in the computer a single shot multibox detector (SSD) algorithm-based fully convolutional neural network model that is trained by learning the characterized images in the step 52;
54, importing a large part of the characterized images in the step 52 to the SSD algorithm-based fully convolutional neural network model on the computer for deep learning training to obtain an image identification model, testing the image identification model with the remaining part of the characterized images, stopping the deep learning training in response to a satisfactory accuracy rate tested, and retaining the trained image identification model; in response to an unsatisfactory accuracy rate tested, continuing with the deep learning training and the testing until the accuracy rate tested is satisfactory, and retaining the trained image identification model; and
55, docking software with the image identification model obtained in the step 54 in the computer and completing the step 41 using the software.
